(19) United States
(12) Patent Application Publication
(10) Pub. No.: US 2017/0270184 A1
(43) Pub. Date: Sep. 21, 2017

(54) METHODS AND DEVICES FOR PROCESSING OBJECTS TO BE SEARCHED

(71) Applicant: EMC IP Holding Company LLC, Hopkinton, MA (US)

(72) Inventors: Kun Wu Huang, Shanghai (CN); Chao Chen, Shanghai (CN); Winston Lei Zhang, Shanghai (CN); Jingjing Liu, Shanghai (CN); Duke Hongtao Dai, Shanghai (CN)

(21) Appl. No.: 15/461,655

(22) Filed: Mar. 17, 2017

(30) Foreign Application Priority Data
Mar. 17, 2016 (CN) 201610154618.2

(51) Int. Cl. G06F 17/30

(52) U.S. Cl. CPC G06F 17/30598; G06F 17/30321

(57) ABSTRACT

Embodiments of the present disclosure provide a method and device for processing objects to be searched. The method comprises: receiviug a first input indicating a constraint associated with an object; receiving a second input indicating a category to which the object belong; and establishing, based on the first input and the second input, a classification condition associating the constraint with the category as a part of a classification policy which is used for classifying the object into a category to create a search index. In addition, embodiments of the present disclosure further disclose a method and device for creating a search index for an object to be searched.

### RELATED APPLICATIONS

This application claim priority from Chinese Patent Application Number CN201610154618.2, filed Mar. 7, 2016 at the State Intellectual Property Office, China, titled “METHOD AND APPARATUS FOR PROCESSING OBJECTS TO BE SEARCHED,” the contents of which is herein incorporated by reference in its entirety

### FIELD

Embodiments of the present disclosure generally relate to the field of data searching, and more specifically, to methods and devices for processing objects to be searched.

### BACKGROUND

The applications for data searching are increasing progressively. Search service system is always dedicated to provide better retrieval experience for the end users, to improve the accuracy and richness of the retrieval results in massive data, and also to enhance the retrieval response time at the meantime. Therefore, how to have the search resources reasonably configured, stored and indexed become vital factors in consideration, such that the search service system is enabled to conduct rapid and accurate retrievals based on a search request, thereby improving robustness and service quality of the search system. In conventional technologies of establishing indexes for search objects, the process of index establishment is generally time-consuming and inefficient. Besides, the process of searching objects based on the established index may also be inefficient, which prolongs system response time and directly degrades user experience.

### SUMMARY

In general, the embodiments of the present disclosure provide a solution of processing objects to be searched through a flexible classification policy.

According to a first aspect of the present disclosure, there is provided a method of processing an object to be searched, comprising: receiving a first input indicating a constraint associated with the object; receiving a second input indicating a category to which the object belong; and establishing, based on the first input and the second input, a classification condition associating the constraint with the category as a part of a classification policy which is used for classifying the objects into a category to create a search index.

In some embodiments, the constraint involves metadata of objects, wherein the metadata describes attributes of the object.

In some embodiments, the constraint involves at least one of scope of metadata or an expression of metadata.

In some embodiments, the expression of metadata comprises at least one of a structured statement describing a location of metadata or a structured statement describing a query related to metadata.

In some embodiments, the constraint involves an attribute of the category.

In some embodiments, the attribute of the category includes at least one of the number of objects contained in the category or a size of storage space occupied by the objects contained in the category.

In some embodiments, the method further comprises: receiving a third input of modifying, a classification condition; and in response to receiving the third input, modifying the classification condition.

According to a second aspect of the present disclosure, there is provided a method for creating a search index for an object to be searched, comprising; receiving the object to be searched; obtaining a classification policy including a set of classification conditions, which associates a set of constraints with corresponding category, and classifying the object into one of the categories through a matching with the constraints in the classification conditions of the classification policy, to create a search index.

In some embodiments, the constraint involves metadata of the object and metadata describing attributes of the object; and classifying the object into one category comprises: obtaining metadata, of the object; classifying the object into the category by matching the metadata with the constraints in the classification conditions.

In some embodiments, the constraint involves an attribute of the categories, and the method further comprises: determining the number of objects currently contained in the category; and classifying the object into one of the categories in which the number of objects is lower than a predetermined threshold. In some embodiments, the constraint involves an attribute of the categories and the method further comprises: determining a size of storage space occupied by objects currently contained in the category; and classifying the object into one of the categories in which objects occupy the size of storage space smaller than a predetermined threshold.

According to a third aspect of the present disclosure, there is provided a device for processing an object to be searched, comprising: at least one processor configured to: receive a first input indicating a constraint associated with the object; receive a second input indicating a category to which the object belong; and establish, based on the first input and the second input, a classification condition associating the constraint with the category as a part of a classification policy which is used for classifying the object into a category to create a search index.

According to a fourth aspect of the present application, there is provided a device for creating a search index fir an object to be searched, comprising: at least one processor configured to: receive the object to be searched; obtain a classification policy including a set of classification conditions, which associates a set of constraints with corresponding categories, and classify the object into one of the categories through a matching with the constraints in the classification conditions of the classification policy, to create a search index.

The embodiments of the present disclosure may implement policy-based object classification mechanism, and thus administrative users can easily and flexibly classify as expected by altering certain configuration items to improve service quality provided by the search system to the end users.

### BRIEF DESCRIPTION OF THE DRAWINGS

Through the following detailed description with reference to the accompanying drawings, the above and other features, advantages and aspects of example embodiments of the present disclosure will become more apparent. In the drawings, identical or similar reference signs indicate identical or similar elements, wherein:

FIG. 1 is a diagram illustrating a part of a search processing system where the embodiments of the present disclosure can be applied.

FIG. 2 shows a flowchart of a method for processing objects to be searched according to the embodiments of the present disclosure;

FIG. 3 shows a flowchart of a method for creating indexes for objects to be searched according to the embodiments of the present disclosure;

FIG. 4 shows a flowchart of a method for creating indexes for objects to be searched according to one embodiment of the present disclosure; and

FIG. 5 illustrates a schematic diagram of an object classification device according to the embodiments of the present disclosure.

### DETAILED DESCRIPTION

The embodiments of the present disclosure are described in details with reference to the drawings. It should be noted that the same reference sign in the drawings represents similar components or function assemblies and the drawings merely aim at explaining the embodiments of the present disclosure. Those skilled in the art can obtain alternative implementations from the following description without departing from the spirit and protection scope of the present application.

As used herein, the term “includes” and its variants are to be read as open-ended terms, that mean “includes, but is not limited to.” The term “based on” is to be read as “based at least in part on.” The term “one embodiment” is to be read as “at least one embodiment” The term “a further embodiment” is to be read as “at least one further embodiment.”

In some search applications, especially in some enterprise search systems, only the search results which the users have sufficient security authority can be returned for the purpose of security concerns. On the other hand, users usually organize the documents in hierarchy folder structure for better findability, and thus the data documents have very little cross-linking. All of the above factors slow down the search response. To solve this problem, embodiments of the present disclosure provide a flexible policy-based classification solution to assist the administrative user to control classification behaviors. Based on the established classification policy, the configuration documents including the configuration items may be provided to the administrative user who in turn can easily achieve the expected classification by changing some configuration items. It is understood that the policy-based classification solution in the present disclosure is not limited to the types of search system and is applicable in any appropriate application scenarios.

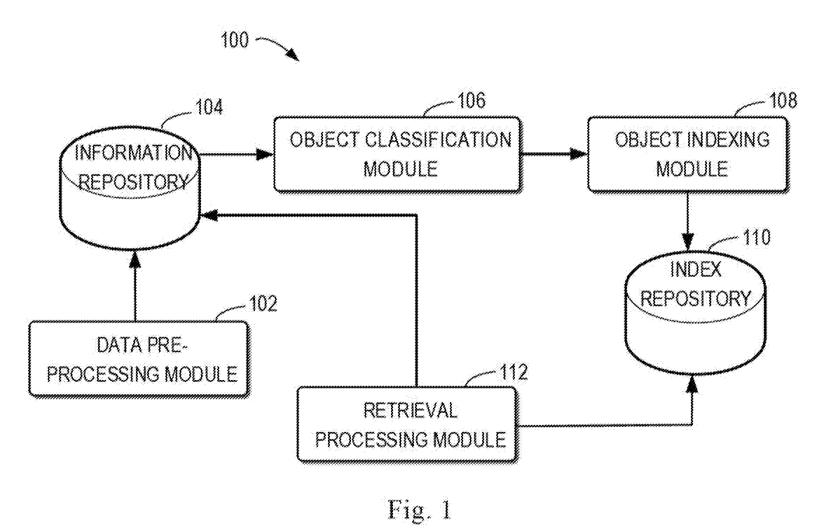

FIG. 1 shows a diagram illustrating a part of a search processing system 100 where the embodiments of the present disclosure can be applied. Generally, the search processing system 100 processes massive data to provide retrieval service as required by the end users. In some embodiments, the search processing system 100 can be established based on the enterprise search application scenarios for example, for searching internal resources within the enterprise to satisfy various data utilization demands.

As shown in FIG. 1, the search processing system 100 comprises a data pre-processing module 102, an information repository 104, an object classification module 106, an object indexing module 108, an index repository 110, and a retrieval processing module 112. It will be appreciated that the search processing system 100 is presented as an example only for the purpose of explanations.

The data pre-processing module 102 may collect all sorts of data sources, such as networks, document library, mail repository and any other entity including the retrieved content on demand. The data sources provide retrievable data for the search processing system 100. These data may be common webpages for instance, and also may comprise documents in various document formats, internal documents of the enterprise (such as technical documents, data documents, emails and agendas etc.), and so on.

Data in the present disclosure is referred to “document” as a typical resource type. The pre-processing module 102 analyzes the documents, marks the documents with a structured method and generates objects in a corresponding uniform format to be processed by the processing of the object classification module 106. As an example, Extensive Markup Language (XML) and JavaScript Object Notations (JSON) are common object notation approaches and easy for the machines to parse and process. The data pre-processing module 102 may represent the documents in such format. For the convenience of discussion, the objects in uniform format generated by each document through the data pre-processing module 102 are regarded as “document objects” or “objects” in short thereinafter.

It will he appreciated that the documents as original data correspond to the document objects generated by the data pre-processing module 102 and the document object is an, object notation for the document. For instance, document objects in the form of XML or JSON may comprise metadata of corresponding documents describing document-related information:, which includes e.g., descriptive elements, technical elements, administrative elements, structural elements etc. The elements may comprise such as simple information of author, title, subject, location and so on, and may also comprise content, carrier, means of location acquisition, means of manufacturing and utilization etc., and may further comprise information associated with document storage, utilization and management, e.g., storage/update time, capacity size, detailed format information, manufacturing information, protection conditions, means of conversion, rights management and electronic signature, to enable functions such as indicating storage location, historical data and resource search and document recording and to help retrieving and confirming the required document resources. The metadata may be automatically generated by the data pre-processing module 102 or added by the administrative user, to ultimately form object notation document in a uniform format.

The information repository 104 can store documents and document objects with uniform format being processed by the data pre-processing module 102. The object classification module 106 classify the objects to be searched from the information repository 104 into different categories, such that the content to be retrieved is divided into smaller processing sets (i.e., categories). That is, the object classification module 106 enables a “routing” function of sorting the objects into different categories. Afterwards, indexes are established for objects according to corresponding categories, such that the retrieval becomes more effective and quicker in response consequently. Besides, the data in different categories is isolated to facilitate fault-tolerance processing, such as, reducing negative impact when partial data encounters unexpected problems (e.g., crash recovery and reestablishment).

The object indexing module 108 performs such as words grouping and semantic analysis on the objects in each category, establishes indexes and stores the index data into the index repository 110. The retrieval processing module 112 searches the index repository 110 and the information repository 104 in response to the retrieval request of the end users and possibly performs other intelligent processing on the indexed objects.

It will be appreciated that the data pre-processing module 102, the object classification module 106, the object indexing module 108 and the retrieval processing module 112 in the search processing system 100 may be implemented as separate module or combined into one or more modules. In addition, the information repository 104 and the index repository 110 in the search processing system 100 are also exemplary, which may also be separate database or combined into one database, or optionally merged with other database in the search processing system 100. It will be appreciated that the search processing system 100 processes the original data documents in various ways to farm “documents” of different forms, which have different “versions” in the information repository 104 and the index repository 110 or other database, but all correspond to the original data document according to respective mapping relationship.

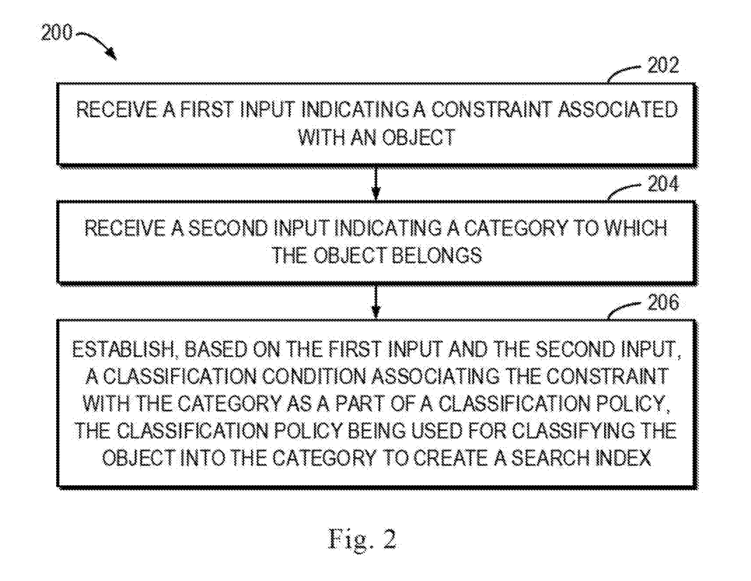

FIG. 2 shows a flowchart of a method 200 for processing objects to be searched according to the embodiments of the present disclosure. At 202, an input (referred to as “first input”) is received, indicating a constraint associated with an object to be searched. In some embodiments, the constraint associated with the object to be searched may comprise a constraint associated with attributes of a single object, e.g., described by metadata of the object. Alternatively or additionally, the constraint may involve a constraint associated with the categories of all objects from the perspective of the search processing system 100, such as the number of objects in each category and so on.

At 204, an input (referred to as “second input”) indicating a category to which the object belong is received, which determines a category into which the object is expected to be classified. That is, the second input indicates the category to which the object should be classified or routed if the object satisfies the constraint specified by the first input.

Next, at 206, based on the first input and the second input, a classification condition associating the constraint with the category is established. The classification condition may be stored as a part of a classification policy for object classification. The classification policy is then used to classify the objects to be processed into corresponding categories, so as to establish search indexes for the objects to be searched based on the categories.

In the embodiments of the present disclosure, the classification policy and the classification conditions therein may be stored as a configuration file, e.g., an XML file. It will be appreciated that XML configuration file is only exemplary, and the classification policy of objects may be stored in an file of other forms, e.g., JSON file etc. The following Table 1 illustrates a pan of the classification policy of an XLM document.

TABLE 1
<domain-collection-routing
class-name=“com.emc.documentum.core.fulltext.indexserver.core.index.routing.CollectionRo
uting” document-category=“dftxml” default-collection=“default”>

<properties>

<property name=“xxxx” value=“xxxx”/>

</properties>
<collection-routing>

<!--Simple rule means the rule can be explained by itself, complex rule means it is

composed of several simple rules joint by: and(‘&’), or(‘|’), not{‘!’), parentheses(‘( )’)-->

<rule name=“xxxx” type=“simple|complex” condition=“” collection=“” />

</collection-routing>

</domain-collection-routing>

The example classification policy of Table 1 comprises a classification condition and a default category, where the classification condition associates the constraint (i.e., condition=“”) with category (i.e., collection=“”). In this example, the constraint is related to the property of objects to be searched, and a default category (i.e., “default”) is additionally configured. If the objects fail to meet the classification condition, they are classified into the default category.

Following examples will be described for a better understanding of the method 200 it in FIG. 2. Those skilled in the an can understand the concept of the present disclosure through reading the following description. However, it will be appreciated that it only serves as examples and is not limited to the presented exemplary classification conditions.

As described above, the metadata of the objects can be descriptive elements, technical elements, administrative elements, structural elements etc. In one embodiment of the present disclosure, the constraint associated with the objects to be searched involves metadata of the objects. Such an example is provided in Table 2.

TABLE 2
<domain-collection-routing
class-name=″FtCollectionRoutingOnFieldValues″
default-collection=″default″ category=”dftxml”>

<properties>

<property name=″routing-field-xpath″
value=″dmftmetadata//file_store″/>

</properties>
<collection-routing>

<rule condition=″file_store_01″ collection=″collection1″/>
<rule condition=″file_store_02″ collection=″collection2″/>

</collection-routing>

</domain-collection-routing>

The example classification policy of Table 2 comprises two classification conditions associated with metadata “document_store”. Specifically, one classification condition provides that if the metadata “file_store” of the objects satisfies the constraint condition=the objects are classified into a category “collection1”. To establish the classification condition, according to method 200, users may respectively input constraint “file_store_01” and category “collection1” at 202 and 204, so that a classification condition <rule condition=“file_store_01” collection=“collection1”/> is established at 206. Similarly, users may establish through method 200 a further classification condition, which provides if “file_store” of objects equals to “file_store02”, the objects are classified into “collection2”. Particularly, in this example, if the metadata value of the incoming objects fails to match the two classification conditions, the objects are classified into the default set (i.e., “default”).

The value comparison while the object classification means 106 classifies the objects is case-sensitive. To facilitate the administrative user to configure, separators are used in one constraint to configure multiple conditions. An example of such is provided in Table 3.

TABLE 3
<domain-collection-routing
class-name=″FtCollectionRoutingOnFieldValues″
default-collection=″default″ category=”dftxml”>

<properties>

<property name=″routing-field-xpath″
value=″dmftmetadata//file_store″/>
<property name=″value-splitter″ value=″,″/>

</properties>
<collection-routing>

<rule condition=″file_store_01, file_store_02″
collection=″collection1″/>
<rule condition=″file_store_08″ collection=″collection2″/>

</collection-routing>

</domain-collection-routing>

In the example of Table 3, a classification condition uses a separator, and thus it is possible to combine, for example, the capitalized metadata value and non-capitalized metadata value of the objects into one classification condition. Specifically, “file_Store01” and “file_store_02” may be different combinations of capitalized and non-capitalized metadata value. If “file_store” of the objects equals to “file_store_01” or “file_store_02”, the objects are classified into “collection1”.

In another example, the constraint associated with the objects to be searched involves a range of metadata. For example, if the administrative user expects to classify the objects according to their content size, the configuration may be set as follows.

TABLE 4
<domain-collection-routing
class-name=″FtCollectionRoutingOnFieldvalueRange″
default-collection=″default″ category=”dftxml”>

<properties>

<property name=″routing-field-xpath″ value=″dmftmetadata//
r_content_size″/>
<property name=″value-type″ value=″Integer″/>
<property name=″value-range-separator″ value=″~″/>

</properties>
<collection-routing>

<rule condition=″40000~80000″″ collection=″collection1″/>
<rule condition=″80000~100000″ collection=″collection2″/>

</collection-routing>

</domain-collection-routing>

The example of Table 4 comprises two classification conditions associated with metadata “r_content_size” and provides the value type of metadata being integer as well as the form of value-splitter of the Value range. Specifically, one classification condition provides that if metadata “r_content_size” of an object satisfies the constraint “condition=“40000˜80000””, that is, the content size of the object is between 40000 and 80000, and then the object is classified into the category “collection1” accordingly. To establish the classification condition, according to method 200, users may respectively input constraint “40000˜80000” and category “collection1” at 202 and 204, so as to establish the classification condition <rule condition=“40000˜80000” “collection=“collection1””/> at 206. Similarly, users may establish another classification condition through method 200, which provides if “r_content_size” of the objects is between 80000 and 100000, the objects are classified into “collection2”. The objects uncovered by the classification condition are classified into default category.

If the constraint of the classification condition involves the value range of metadata, the classification condition is configured to be inclusive. In other words, if an object satisfies two classification conditions, the first classification condition is used. For instance, if the content size of an object is 8000 in the example, it is classified into “collection1”,

Generally, character string is a default type for value comparison. If the administrative user expects to define non-string type, it is necessary to set the value-type, e.g., integer, double, datetime etc., in the property section. For Datetime, it needs to be is unified as UTC time (“yyyy-MM-dd‘T’HH:mm:ss”). If the metadata of document objects is not presented in, right data format, such as placing character string into integer attribute, the value comparison will fall back to use character string comparison to determine category.

If the administrative user has some special requirements on metadata, the regular expression for the metadata is taken into account to define constraint of the category. The following is an example of such.

TABLE 5
<domain-collection-routing
class-name=″FtCollectionRoutingOnFieldValueWithRegularExpression″
default-collection=″default″ category=”dftxml”>

<properties>

<property name=″routing-field=xpath″
value=″dmftmetadata//object_name″/>

</properties>
<collection-routing>

<rule condition=″per.″ collection=″collection1″/>
<rule condition=″ber.″ collection=″collection2″/>

</collection-routing>

</domain-collection-routing>

The example classification policy of Table 5 comprises two classification conditions associated with metadata “object_name”. Specifically, one classification condition provides if metadata “object_name” of the object meets the constraint “condition=per.”, meaning the “object_name” starts with “per”, and the object is classified into the category “collection1”. To establish the classification condition, according to method 200, users may respectively input constraint “per,” and category “collection1” at 202 and 204, to establish classification condition <rule condition=“per.” collection=“collection1”/> at 206. Similarly, users may establish another classification condition through method 200, which provides if “object_name” of the object starts with “ber”, the object is classified into “collection2”. Particularly, in this example, if the metadata of the incoming object does not match the two classification conditions, the object is classified into a default set (here is “default”). It will be appreciated that Table 5 only illustrates an example using the regular expression. In examples where classification constraint is specified by the regular expression of metadata, objects are classified through vague classification matching instead of an accurate one, in order to satisfy the needs of the administrative user.

In a more complicated situation, if the administrative user expects to mute the objects according to multiple paths, a structured statement describing location of metadata is utilized. An example of the structured statement is XPath, which complies with W3C standard. An exemplary embodiment is described below with XPath as an example arid the exemplary configuration is as follows.

TABLE 6
<domain-collection-routing class-name=″FtCollectionRoutingOnOnXPath″
default-collection=″default″ category=”dftxml”>

<properties>
</properties>
<collection-routing>

<rule condition=″boolean(/dmftdoc//i_folder_id=′3456789′)″
collection=″collection1″/>
<rule condition=″ boolean(/dmftdoc//i_folder_id=′456789′
‘and’ /dmftdoc//owner_name=′test′)″ collection=″collection2″/>

</collection-routing>

</domain-collection-routing>

The example classification policy of Table 6 comprises two classification conditions associated with metadata “i_folder_id” and “owner_name”. Specifically, one classification condition provides that for all sub-elements “i_folder_id” under root elements “/dmftdoc” of XML file, objects that satisfy the constraint of being equal to “345678” are classified into category “collection1”. To establish the classification condition, according to method 200, users may respectively input constraint “boolean(/dmftdoc//i_folder_id=‘3456789’)” and category “collection1”, so as to establish the classification condition <rule condition=“boolean(/dmftdoc//i_folder_id=‘3456789’)” collection=“collection1”/> at 206. Similarly, users may establish another classification condition through method 200, which provides that for all sub-elements “i_folder_id” and “owner_name” under root elements “/dmftdoc” of XML file, if “i_folder_id” of objects equals to “456789” and “owner_name” equals to “test”, the objects are classified into “collection2”. Particularly, in this example, if the metadata value of the incoming object fails to match the two classification conditions, the objects are classified into a default set (here is “default”). The complicated classification conditions can be configured through constructing XPath, such as classifying category based on multiple metadata and in accordance with XPath criteria.

Alternatively or additionally, a structured statement describing a query related to object metadata is used to classify the objects. An example of the structured statement is XQuery, which also complies with. W3C standard and is implemented for performing powerful queries. An exemplary configuration of object classification according to XQuery is shown below.

TABLE 7
<domain-collection-routing
class-name=″FtCollectionRoutingOnOnXQuery″
default-collection=″default″ category=”dftxml”>

<properties>
</properties>
<collection-routing>

<rule condition=″ boolean(/dmftdoc[dmftmetadata//object_name
contains text ‘test1234’])″ collection=″collection1″/>
<rule condition=″ boolean(/dmftdoc[dmftmetadata//object_name
contains text ‘test3456’ and dmftmetadata//key_words contains
text ‘testing’])″ collection=″collection2″/>

</collection-routing>

</domain-collection-routing>

The example classification policy of Table 7 comprises two classification conditions associated with “object_name” and “key_words”. Specifically, one classification condition provides that under root elements “/dmftdoc” of the XML file, the objects that satisfy the constraint of “object_name” containing “test1234” are classified into the category “collection1”. To establish the classification condition, according to method 200, users may respectively input constraint “boolean(/dmftdoc[dmftmetadata//object_name contains text ‘test1234’])” and category “collection1” at 202 and 204, so as to establish the classification condition <rule condition=“boolean(/dmftdoc[dmftmetadata//object_name contains text ‘test1234’])” collection=s“collection1”/> at 206. Similarly, users may establish another classification condition through method 200, which provides that under root elements “/dmftdoc” of the XML document, if “object_name” of objects contains “test 3456” and “key_words” contains “testing”, the objects are classified into “collection2”. Particularly, in this example, if the metadata of the incoming Objects fail to match the two classification conditions, the objects are classified into a default set (here is “default”),

The classification according to the above policy brings high efficiency as well as relatively high management costs. One possibility of the above classification policy may cause is unequal size of each category and unbalanced traffic of each category with the corresponding classification process. The imbalance of these two dimensions requires a more complicated index deployment solution. One option is that the classification policy may be determined based on the dynamic statistics of the category. For example, the classification condition may involve the properties of the category, such as die number of objects contained in the category and size of storage space occupied by the objects contained in the category.

In this regard, apart from the object metadata, information associated with the category is also considered as a substitution in the object classification. As an example, during object classification, in one embodiment, each category is maintained to have identical or approximate number of objects. Alternatively or additionally, each category has approximate storage size during object classification in some embodiments. The exemplary configuration is as follows.

TABLE 8
<domain-collection-routing class-name=″FtCollectionRoutingOnWeights″
default-collection=″default″ category=”dftxml”>

<properties>

<property name=″weight-collection-size″ value=″true″/>
<property name=″weight-storage-size″ value=″true″/>

</properties>

</domain-collection-routing>

In the example of Table 8, two classification conditions are configured as enabled (i.e., both as “true”). In this case, the first classification condition (“weight-collection-size”) is used, i.e., each category is maintained to have approximate number of objects. It is possible that only one of to classification conditions is configured as enabled.

If the above classification policy cannot satisfy the needs of the administrative user, self-defined classification may be configured. An exemplary implementation and configuration is shown below.

TABLE 9

<domain-collection-routing class-name=″MyRoutingExample″
default-collection=″default″ category=”dftxml”>

<properties>

<property name=″my_property″
value=″dmftmetadata//my_field″/>

<property name=″operator″ value=″contains″/>

</properties>
<collection-routing>

<rule criteria=″test12345″ collection=″collection1″/>
<rule criteria=″test3456″ collection=″collection2″/>

</collection-routing>

</domain-collection-routing>

The example of Table 9, a class “MyRoutingExample” is customized, which provides properties of the objects associated with classification and two classification conditions. Take “my_field” as an example, documents comprising “test12345” will be classified into “collection1” and documents comprising “test3456” will be classified into “collection2”. “Contains” can be simply changed into “startsWith” or “endsWith” or other operators. In such case, the class MyRoutingExample is performed to support the expected logic, and the above configuration is placed into the object classification module 100 as an example to ensure that the operation proceeds according to expected classification.

The above examples illustrate several classification polices of the present disclosure. The administrative user only needs to set configuration items. The setting may be performed manually or through the provided user input interface. It is apparent that the classification policy should be configured through careful review of the application scenarios, e.g., selection of constraints in the classification policy and sequence of the classification conditions, which directly impacts the classification and retrieval effect.

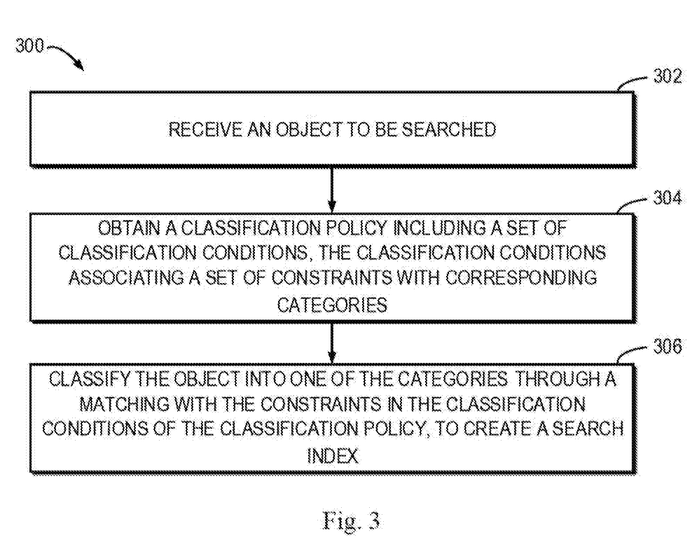

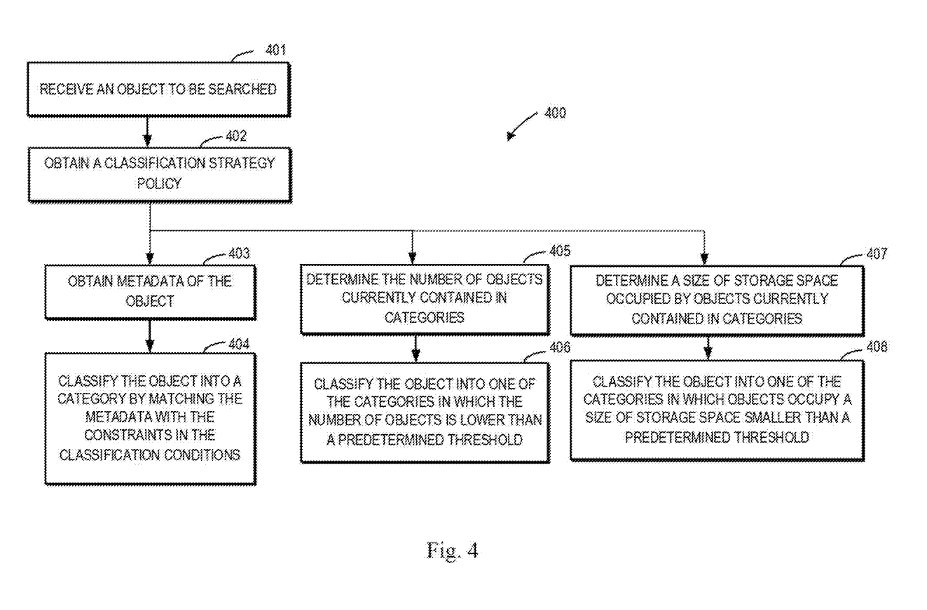

After configuration, the classification policy may be stored as configuration files for instance. The object classification module 106 may classify the objects. FIG. 3 shows a flowchart of a method 300 for creating indexes for objects to be searched according to the embodiments of the present disclosure. At 302, an object to be searched is received. The object may be documents having uniform format, e.g., XML, and including metadata and stored in the information repository 104. Next, a classification policy including as set at classification conditions is obtained at 304. The classification conditions associate a set of constraints with corresponding categories. As described above, the objects are classified or routed as expected per traffic requirements in accordance with method 200, to establish a classification policy. In the above embodiment, the classification policy forms XML configuration files and the object classification module 106 may obtain configuration files including a classification policy. At 306, the object is classified into one of the categories through a matching with the constraints in the classification conditions of the classification policy, so as to create a search index. The objects to be searched are classified into the corresponding categories one by one based on the classification conditions, such that the object indexing module 108 can further process the objects and create search indexes. Explanation is further provided below with reference to FIG. 4.

FIG. 4 shows a flowchart of a method 400 for creating an index for an object to be searched according to one embodiment of the present disclosure. At 401, an object to be searched is received. Then, the object classification module 106 for example obtains the established classification policy as described above and parses the classification policy, i.e., through a matching with the constraints in the classification conditions of the classification policy. If the constraint involves metadata of the object, proceed to block 403 to obtain metadata of the object. The metadata of the object presents in the metadata file of the object (i.e., document object) is stored, e.g., in the XML files of the information repository 104 as described above. Therefore, the object classification module 106 may obtain metadata of the object from the information repository 104. Then at 404, metadata of the object is matched with the constraints in the classification conditions based on the configured classification policy and the object is classified into one category configured in the classification policy in response to the matching result. Based on the category types of the objects, the object indexing module 108 may create a search index for the object.

If the classification policy involves an attribute of the categories, for example, in one embodiment described above, the corresponding value of “weight-collection-size” is configured as “true”, that is, the classification condition involves the number of objects contained in the category, then the method 400 proceeds to 405. The number of objects currently contained in the category is calculated and determined at 405. The objects are classified or routed based on the number of objects “carried” by the categories, thereby balancing the number of objects in the categories to simplify object indexing deployment and enhance retrieval efficiency. At 406, the object is classified or routed according to a predetermined threshold of object amount included in the categories. As an example of the least-policy, the category having least object amount is a target category of object classification. Alternatively, a threshold of object amount in the categories is predetermined. For the categories having the number of objects lower than the threshold, the coming objects are classified or routed into one of these categories based on an appropriate or a random manner. The object indexing module 108 may, based on the category types of the objects, create a search index for the objects.

For a further aspect, if the classification policy involves an attribute of the categories, e.g., in one example described above, the corresponding value of “weight-collection-size” is configured as “true”, that is, the classification condition involves a size of storage space occupied by objects contained in the categories, the method 400 proceeds to block 407. The size of storage space occupied by objects currently contained in the categories is calculated and determined at 407. The objects are classified or routed based on the storage size “carried” by the categories, thereby balancing the storage size in the categories to simplify object indexing deployment and enhance retrieval efficiency. At 408, the object is classified or routed according to a predetermined threshold of the size of storage space occupied by objects contained in the categories. As an example of the least-policy, the category having minimum space storage occupied by objects is a target category of object classification. Alternatively, a threshold of the size of storage space occupied by objects contained in the categories is predetermined. For the categories having storage space smaller than the threshold, the, coming objects are classified or routed into one of the categories based on an appropriate or a random manner. The object indexing module 108 may, based on the category types of the objects, create a search index for the objects.

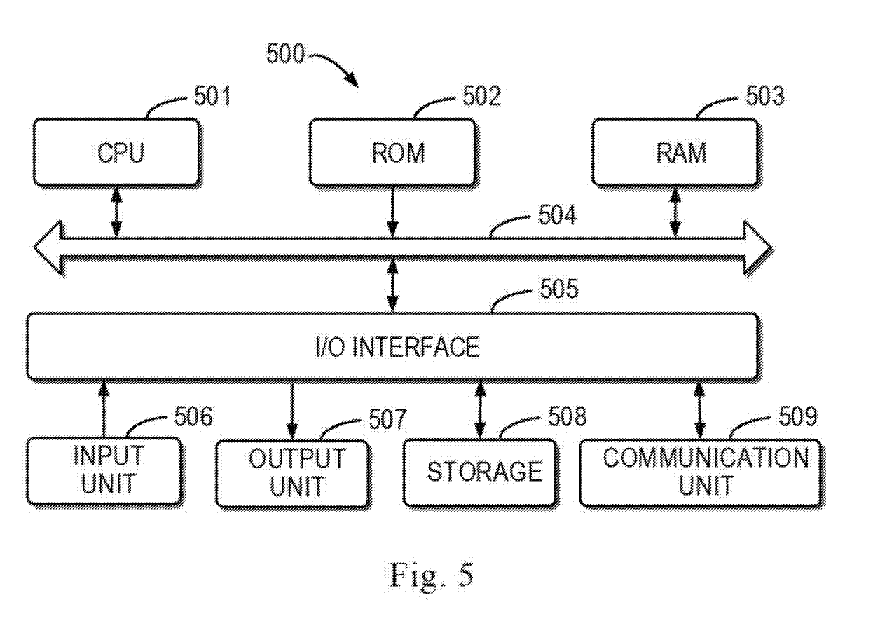

The above methods 200, 300 and 400 can be implemented by the object classification module 106. Alternatively, at least a part is implemented as a software module. FIG. 5 illustrates a schematic diagram of a device 500 for implementing the embodiments of the present disclosure. The device 500 can serve as an object classification apparatus, e.g., the object classification module 106 as described above.

As shown in FIG. 5, the device 500 comprises a central processing unit (CPU) 501 executing, based on the computer program instructions stored in read-only memory (ROM) 502 or computer program instructions loaded to the random-access memory (RAM) 503 from the memory unit 508, various suitable actions and processing. Besides, RAM 503 can also store various programs and data required by the device 500. CPU 501, ROM 502 and RAM 503 are connected with each other by bus 504. An Input/Output (I/O) interface 502 is also connected to the bus 504.

Multiple components in the device 500, connected to the I/O interface 505 and comprising an input unit 506, e.g., a keyboard and a mouse; an output unit 507, e.g., various types of displays and loudspeakers; a storage 508, e.g., disk and optical, disk; and a communication unit 509, e.g., a network interface card, a modem and a wireless communication transceiver. The communication unit 509 allows the device 500 to exchange information/data with other devices through computer network and/or other telecommunication networks, such as Internet.

The above described process and processing, e.g., method 200, 300 and 400, can be executed by a processing unit 501. For example, in some implementations, method 300 and method 400 are implemented as computer software program, which is physically included in the machine-readable medium, such as the storage 508. In some embodiments, part of or the entire computer program ran be loaded and/or installed in, the device 500 through ROM 502 and/or the communication unit 509. When the computer program is loaded on RAM 503 and executed by CPU 501, one or more steps of method 200, 300 and 400 are implemented.

Through the teaching suggested b above description and related drawings, those skilled in the art become aware of the multiple modifications and other implementations of the present disclosure. Therefore, it should be understood that the embodiments of the present disclosure are not limited to the specific implementations of the present disclosure and modifications and other implementations are within the scope of the present disclosure. In addition, although the above description and related drawings describe the exemplary embodiments in the context of certain example combinations of components and/or functions, it should be realized that different combinations of components and/or functions are also provided by the alternative embodiments without departing from the scope of the present disclosure. From this point, other combinations of components and/or functions that are different from the above specified ones are also expected to fall within the scope of the present disclosure. Although specific terms are employed here, they only convey general and descriptive meaning without intentions of putting limitations on the present disclosure.

1. A method of processing an object to be searched, comprising:
receiving a first input indicating a constraint associated with the object;
receiving a second input indicating a category to which the object belong; and
establishing, based on the first input and the second input, a classification condition associating the constraint with the category as a part of a classification policy, the classification policy being used for classifying the object into the category to create a search index.

2. The method of claim 1, wherein the constraint involves metadata of the object, the metadata describing attributes of the object.

3. The method of claim 2, wherein the constraint involves at least one of a scope of the metadata or an expression of the metadata.

4. The method of claim 3, wherein the expression of the metadata comprises at least one of:
a structured statement describing a location of the metadata, or a structured statement describing a query related to the metadata.

5. The method of claim 1, wherein the constraint involves an attribute of the category.

6. The method of claim 5, wherein the attribute of the category comprises at least one of:
the number of objects contained in the category; or
a size of storage space occupied by objects contained in the category.

7. The method of claim 1, further comprising:
receiving a third input of modifying the classification condition; and
in response to receiving the third input, modifying the classification condition.

8. A method for creating a search index for an object to be searched, comprising:
receiving the object to be searched;
obtaining a classification policy including a set of classification conditions, the classification conditions associating a set of constraints with corresponding categories, and
classifying the object into one of the categories through a matching with the constraints in the classification conditions of the classification policy, to create a search index.

9. The method of claim 8, wherein the constraints involve metadata of the object and metadata describes attributes of the object; and classifying the object into one category comprises:
obtaining the metadata of the object; and
classifying the object into the category by matching the metadata with the constraints in the classification conditions.

10. The method of claim 8, wherein the constraints involve an attribute of the categories, and the method further comprises:
determining the number of objects currently contained in the categories; and
classifying the object into one of the categories in which the number of objects is lower than a predetermined threshold.

11. The method of claim 8, wherein the constraints involve an attribute of the categories and the method further comprises:
determining a size of storage space occupied by objects currently contained in the categories; and
classifying the object into one of the categories in which objects occupy the size of storage space smaller than a predetermined threshold.

12-24. (canceled)
